(19) United States
(12) Patent Application Publication
(10) Pub. No.: US 2006/0143674 A1
(43) Pub. Date: Jun. 29, 2006

(54) Methods to adapt search results provided by an integrated network-based media station/search engine based on user lifestyle

(75) Inventors: Courtney P. Jones, Ft. Myers, FL (US); Michael R. Roe, Vilas, NC (US)

Correspondence Address: HAHN LOESER & PARKS, LLP, One GOJO Plaza, Suite 300, AKRON, OH, 44311-1076, US

(73) Assignees: Blu Ventures, LLC; ioMedia Partners, LLC

(21) Appl. No.: 11/183,180

(22) Filed: Jul. 15, 2005

Related U.S. Application Data
(63) Continuation-in-part of application No. 10/664,407, filed on Sep. 19, 2003.
(63) Continuation-in-part of application No. 11/066,623, filed on Feb. 25, 2005.
(60) Provisional application No. 60/588,565, filed on Jul. 16, 2004.
(60) Provisional application No. 60/588,934, filed on Jul. 16, 2004.
(60) Provisional application No. 60/588,568, filed on Jul. 16, 2004.
(60) Provisional application No. 60/588,566, filed on Jul. 16, 2004.
(60) Provisional application No. 60/588,567, filed on Jul. 16, 2004.

(51) Int. Cl. H04N 7/173; G06F 3/00; H04N 7/16; G06F 13/00; H04N 5/445; G06F 7/00

(52) U.S. Cl. 725/113; 725/135; 725/112; 725/46; 707/3

(57) ABSTRACT

Methods to adapt a user interface view, provided by an integrated media/search web site via a global informational network, based on a user's lifestyle are disclosed. The methods include populating a user interface view of the integrated web site with a first set of links to the global informational network, wherein the integrated web site integrates a streaming digital media provider station with a global search engine. A user selects a link from the first set of links or performs a key word search using the global search engine. The user interface view is then re-populated with an updated set of links to the global informational network based on demographic and psychographic associations made by the global search engine in response to at least the most recently selected link, the most recent key word search, or the most recent streaming media content. If a new link or a new key word search is performed, the user interface view is again re-populated with an updated set of links. Also, if the streaming media program content from the provider changes, the user interface view is again re-populated with an updated set of links.

### CROSS-REFERENCE TO RELATED APPLICATIONS/INCORPORATION BY REFERENCE

This application claims priority to the following U.S. patent applications:

U.S. patent application Ser. No. 10/664,407, entitled “A Method for Operating an Internet Broadcasting Station” filed on Sep. 19, 2003, which is incorporated herein by reference in its entirety.

U.S. provisional patent application Ser. No. 60/547,765 filed Feb. 25, 2004 and U.S. patent application Ser. No. 11/066,623 filed Feb. 25, 2005, both entitled “Methods to Adapt Search Results Provided by an Integrated Network-Based Media/Search Engine Based on User Lifestyle”, both of which are incorporated herein by reference in their entirety.

U.S. Provisional Patent Application Ser. No. 60/588,934, entitled “Methods to Adapt Search Results Provided by an Integrated Network-Based Media Station/Search Engine Based on User Lifestyle” filed Jul. 16, 2004, which is incorporated herein by reference in its entirety.

U.S. Provisional Patent Application Ser. No. 60/588,565, entitled “A Method to Access and Use an Integrated Web Site in a Mobile Environment” filed Jul. 16, 2004, which is incorporated herein by reference in its entirety.

U.S. Provisional Patent Application Ser. No. 60/588,568, entitled “A Method to Generate Revenue for a Global Informational Network-Based Media Provider” filed Jul. 16, 2004, which is incorporated herein by reference in its entirety.

U.S. Provisional Patent Application Ser. No. 60/588,566, entitled “Systems and Methods to Provide Internet Search/Play Media Services” filed on Jul. 16, 2004, which is incorporated herein by reference in its entirety.

U.S. Provisional Patent Application Ser. No. 60/588,567, entitled “Method to Promote Branded Products and/or Services” filed on Jul. 16, 2004, which is incorporated herein by reference in its entirety.

### TECHNICAL FIELD

Certain embodiments of the present invention relate to searching and program broadcasting. More particularly, certain embodiments of the present invention relate to a method to adapt search results based on user media program selections, web site selections, and collected user demographic information.

### BACKGROUND OF THE INVENTION

Traditional broadcasting, such as radio or television, combines programming content (such as entertainment content or news content) with commercial advertising content. Programming content is periodically interrupted by commercial advertising content in units of, typically, 30 seconds and 60 seconds to generate income. A user of the broadcast is forced to wait until the commercial advertising segment is finished before he is able to resume consumption of programming content.

On the Internet, search engines are used to find sources of information, media content, and advertisers. Advertisers pay the provider of the search engine to be found and are ranked according to bid, with the highest bid appearing first in a search list on the users PC (personal computer) screen. U.S. Pat. No. 6,269,361 describes such a bidding methodology.

Users enter key search words to perform a search and the search engine provides a list of search results in the form of links to web sites. One of the drawbacks of current search engines is that they typically do not take into consideration any information about the user to provide a better search result that is more pertinent to the user's interests. A search engine may simply “know” that users who have searched for “A” have also searched for “X”, “Y”, and “Z”. Searching today provides mostly sterile and often static listings of URL's that point to sites based on a Boolean search. Results often lack any real relevancy and often, users have to refine and refine to finally get what they are looking for.

Internet radio stations provide programming content and allow advertisers to provide “pop-up” icons that a user can click on to go to the web sites of the advertisers. Internet radio stations often require users to subscribe to the radio station in order to access programming content of the radio station. The subscription usually involves paying a fee.

Public broadcasting, such as public radio or TV, typically depends upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

Further limitations and disadvantages of conventional, traditional, and proposed approaches will become apparent to one of skill in the art, through comparison of such systems with the present invention as set forth in the remainder of the present application with reference to the drawings.

### BRIEF SUMMARY OF THE INVENTION

A first embodiment of the present invention comprises a method to adapt a user interface view, provided by an integrated media/search web site via a global informational network, based on a user's lifestyle. The method comprises populating the user interface view with a first set of links to the global informational network. The integrated web site integrates at least one streaming digital media provider station with at least one global search engine. The method further comprises selecting a link from the first set of links and re-populating the user interface view with a second set of links to the global informational network based on demographic and psychographic associations made by the global search engine in response to selecting the first link. The method also includes selecting a second link from the second set of links and re-populating the user interface view with a third set of links to the global informational network based on demographic and psychographic associations made by the global search engine in response to selecting at least the second link.

A second embodiment of the present invention comprises a method to adapt a user interface view, provided by an integrated media/search web site via a global informational network, based on a user's lifestyle. The method comprises populating the user interface view with a first set of links to the global informational network, wherein the integrated web site integrates at least one streaming digital media provider station with at least one global search engine. The method further comprises entering at least one first search key word into a key search word text entry box of the user interface view and initiating a first search of the global informational network based on the at least one first search key word using the global search engine. The method also includes re-populating the user interface view with a second set of links to the global informational network based on demographic and psychographic associations made by the global search engine in response to the at least one first search key word.

A third embodiment of the present invention comprises a method to adapt a user interface view, provided by an integrated media/search web site via a global informational network, based on a user's lifestyle. The method comprises populating the user interface view with a first set of links to the global informational network, wherein the integrated web site integrates at least one streaming digital media provider station with at least one global search engine. The method further comprises selecting a first link from the first set of links and re-populating the user interface view with a second set of links to the global informational network based on demographic and psychographic associations made by the at least one global search engine in response to the selected first link.

A fourth embodiment of the present invention comprises a method to adapt a user interface view, provided by an integrated media/search web site via a global informational network, based on a user's lifestyle. The method comprises populating the user interface view with a first set of links to the global informational network, wherein the integrated web site integrates at least one streaming digital media provider station with at least one global search engine. The method further comprises selecting a first link to download a first streaming media program content followed by at least a second streaming media program content to a user's personal computer (PC). The method also includes re-populating the user interface view with a second set of links to the global informational network based on demographic and psychographic associations made by the global search engine in response to the first streaming media program content. The method further includes re-populating the user interface view with a third set of links to the global informational network based on demographic and psychographic associations made by the global search engine in response to the second streaming media program content.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a schematic block diagram of an embodiment of a personal computer (PC) system displaying an integrated, Internet-based media/search (IIM/S) user interface view having an Internet radio station sub-view and a search tool sub-view displayed on a screen of the PC system, in accordance with various aspects of the present invention.

FIG. 2 illustrates a schematic block diagram of an embodiment of a system providing integrated streaming digital media and Internet search capability to the PC system of FIG. 1, in accordance with various aspects of the present invention.

FIG. 3 is a flowchart of an embodiment of a method to adapt the user interface view of FIG. 1 based on user actions using the system of FIG. 2, in accordance with various aspects of the present invention.

FIG. 4 illustrates a first exemplary embodiment of a IIM/S user interface view provided by the system of FIG. 2, in accordance with various aspects of the present invention.

FIG. 5 illustrates a second exemplary embodiment of a IIM/S user interface view provided by the system of FIG. 2, in accordance with various aspects of the present invention.

FIG. 6 illustrates a third exemplary embodiment of a IIM/S user interface view provided by the system of FIG. 2, in accordance with various aspects of the present invention.

FIG. 7 illustrates a fourth exemplary embodiment of a IIM/S user interface view provided by the system of FIG. 2, in accordance with various aspects of the present invention.

FIG. 8 illustrates a fifth exemplary embodiment of a IIM/S user interface view provided by the system of FIG. 2, in accordance with various aspects of the present invention.

FIG. 9 illustrates a sixth exemplary embodiment of a IIM/S user interface view provided by the system of FIG. 2, in accordance with various aspects of the present invention.

FIG. 10 illustrates an embodiment of the user interface view of FIG. 8 showing the ability to rate a currently playing song, in accordance with various aspects of the present invention.

FIG. 11 illustrates an embodiment of the user interface view of FIG. 8 showing the ability to access news stories and other stories, in accordance with various aspects of the present invention.

FIGS. 12-14 each illustrate an exemplary embodiment of a user interface view for a unique radio station, in accordance with various aspects of the present invention.

FIGS. 15-17 each illustrate an exemplary embodiment of a user interface view having a selected embedded media player, in accordance with various aspects of the present invention.

FIG. 18 illustrates an exemplary embodiment of a user interface view showing certain user-selectable choices, in accordance with various aspects of the present invention.

### DETAILED DESCRIPTION OF THE INVENTION

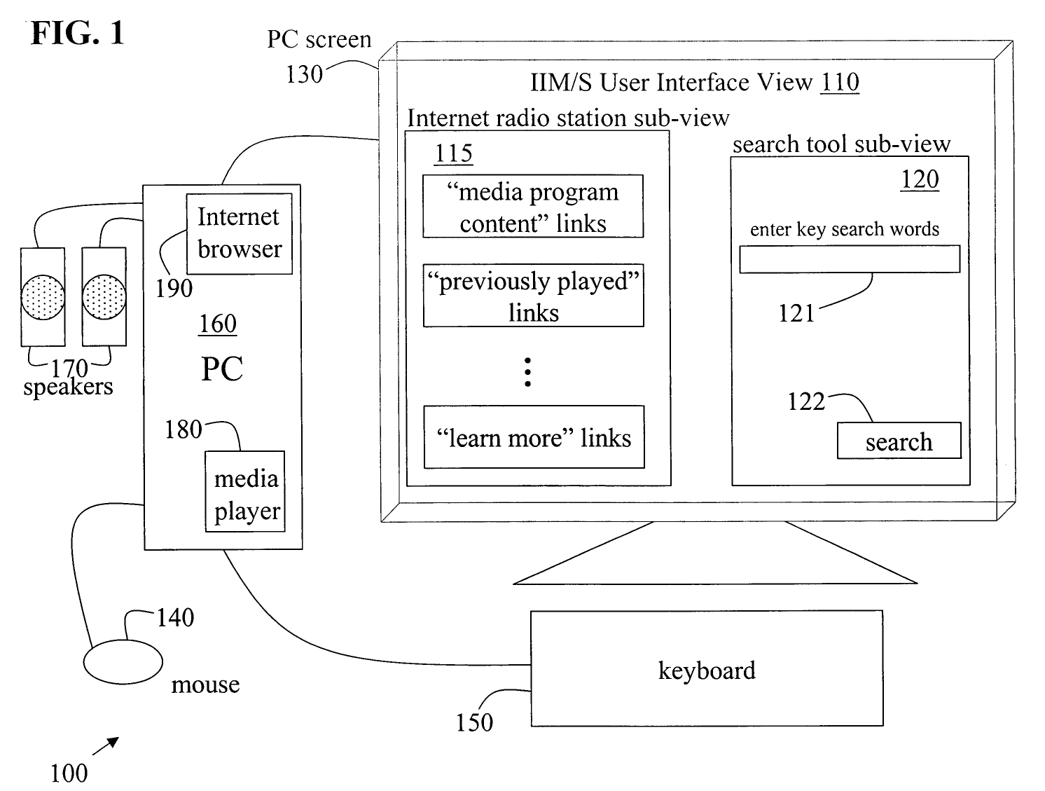

FIG. 1 illustrates a schematic block diagram of an embodiment of a personal computer (PC) system 100 displaying an integrated, Internet-based media/search (IIM/S) user interface view 110 having an Internet radio station sub-view 115 and a search tool sub-view 120 displayed on a screen 130 of the PC system 100, in accordance with various aspects of the present invention.

Referring to FIG. 1, in accordance with an embodiment of the present invention, the PC system 100 includes the screen 130, a mouse 140, a keyboard 150, a PC processing unit 160, and speakers 170. The PC screen 130, the mouse 140, the keyboard 150, and the speakers 170 each interface to the PC processing unit 160. The PC processing unit 160 includes a media player module 180 capable of processing and playing digital streaming media such as, for example, streaming audio and/or streaming video. The PC processing unit 160 also includes an Internet browser 190 capable of accessing web addresses on the Internet.

The present invention is not limited to the type of media consumed by the user, and although examples may relate to embodiments of Internet radio and the like, any other media consumed by users is contemplated herein. For example, a user may access media in the form of an on-line book or on-demand media, wherein the subject matter of the book, the author or other attributes of the material is used to provide search results according to the invention. Thus, a user may be accessing media at sites like Amazon.com or the like, and the concepts of the invention implemented to provide search information to the user according to the invention. Alternatively, the user may access media via a site such as Encarta.com, wherein the user may access media via the on-line encyclopedia, and the media used to provide search results according to the invention. For example, the user may view of photograph of the Mona Lisa, with search results generated according to the invention to provide information on the artist, period of other aspects related to this content. Thus, as should be evident, any type of media consumed by a user is contemplated in the invention.

In accordance with an alternative embodiment of the present invention, the PC processing unit 160 may not include a media player module 180. Instead, a media player object embedded into a user interface view may be provided by a provider of, for example, an Internet radio station.

In accordance with an embodiment of the present invention, the media player module 180 comprises a software module residing within the PC processing unit 160. In accordance with an embodiment of the present invention, the web browser 190 comprises a software module residing within the PC processing unit 160.

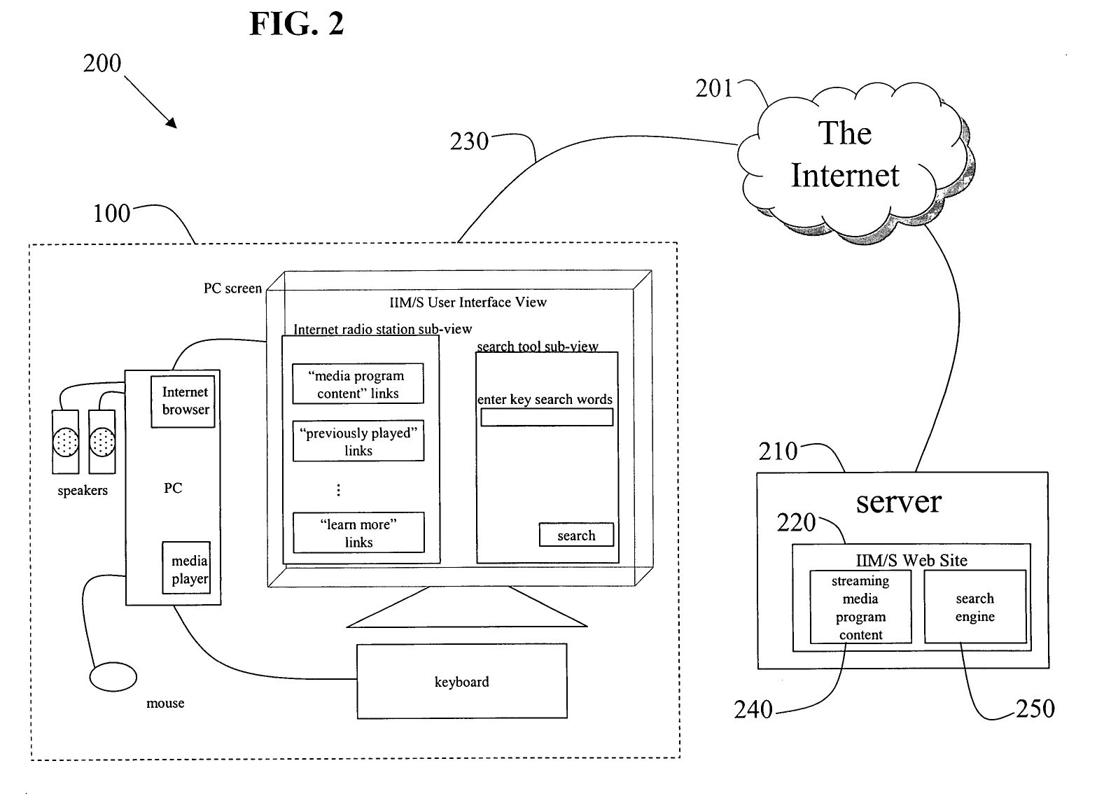

FIG. 2 illustrates a schematic block diagram of an embodiment of a system 200 providing integrated streaming digital media and Internet search capability to the PC system 100 of FIG. 1, in accordance with various aspects of the present invention. The system 200 comprises the Internet 201 and a server 210. The server 210 interfaces to the Internet 201. The server 210 hosts an IIM/S website 220 which provides the IIM/S user interface view 110 of FIG. 1, in accordance with various aspects of the present invention.

Referring to FIG. 2, a user of the PC system 100 may connect to the Internet 201 via traditional means such as a dial-up connection or a cable modem connection 230, for example, and access the IIM/S website 220. The connection to the Internet 201 may be wired or wireless. In accordance with an embodiment of the present invention, the IIM/S website 220 is hosted on the server 210 on the Internet 201 and is configured as an Internet radio station that provides various streaming media program content 240 (such as, for example, music) and various display views (e.g., 110) to the PC system 100 via the established Internet connection. The IIM/S website 220 also comprises an integrated search engine 250 corresponding to the search tool sub-view 120.

In accordance with various alternative embodiments of the present invention, the Internet 201 may instead comprise some other global informational network. In general, streaming media program content comprises at least one of streaming digital audio or streaming digital video in the form of, for example, musical pieces (e.g. songs), human discourse (e.g., talk radio), television programs, music videos, news programs, etc.

The IIM/S user interface view 110 provided by the IIM/S website 220 is displayed on the screen 130 of the PC system 100 to the user. In accordance with an embodiment of the present invention, the IIM/S user interface view 110 includes an Internet radio station sub-view 115 with various link choices (e.g., “media program content” links, “previously played” links, “learn more” links, other links, etc.) and a search tool sub-view 120. The various link choices are provided by the IIM/S website 220 to the PC system 100. For example, when a user clicks on a “media program content” link, streaming digital media content 240 is routed from the server 210 to the PC 100 via the Internet 201. The media player 180 receives and plays the streaming digital media content 240 (e.g., a musical piece) through the speakers 170.

The “media program content” link choices displayed in the sub-view 115 may include links to individual musical pieces or songs, an album of musical pieces or songs, songs of a particular artist, a category or genre of musical pieces or songs, talk radio shows, news, etc. For example, a first media program content link may be the category of music called “Classic Rock”. When a user clicks on the “Classic Rock” category, streaming digital audio of classic rock music is transmitted from the server 210 to the PC system 100. Alternatively, when a user clicks on the “Classic Rock” category, another set of links is displayed to the user which provides choices of songs of individual musical artists that the user may select. Other arrangements are possible as well, in accordance with various embodiments of the present invention.

The search tool sub-view 120 includes a text entry area 121 to enter key search words, and a “search” or “go” icon 122 to initiate a search. A user may use the mouse 140 or the keyboard 150 of the PC system 100 to select any of the link choices and to enter key search words in the text entry area 121 to perform a search on the Internet 201. In accordance with an embodiment of the present invention, at least the entire World Wide Web (WWW) is available for searching via the search tool sub-view 120 using the search engine 250.

In accordance with an embodiment of the present invention, the user may use the search engine 250 while listening to the streaming digital media program content without interrupting the streaming digital media program content. The user may proceed to input key search words into the search tool sub-view 120 using, for example, the keyboard 150 in order to look for other web sites on the Internet 201. The web sites that a user may search for may include many different types of web sites that are hosted on the Internet 201, including web sites of advertisers who are sponsors of the Internet radio station.

As an example, referring to FIG. 2, a user of the PC system 100 accesses the IIM/S website 220 (e.g., an Internet radio station) and views the IIM/S user interface view 110. The user then clicks on a “media program content” link, for example, to initiate the reception of streaming digital audio, via the Internet 201, from the server 210 which is hosting the IIM/S website (i.e., the Internet radio station). Once the user is comfortably listening to the selected media program content (which may be, for example, classical music), the user may then begin entering key search words into the search tool sub-view 120 to leisurely search the Internet 201 while listening to the streaming audio.

Also, in accordance with an embodiment of the present invention, the user may click on various link choices in the sub-view 115 while listening to the streaming digital media program content without interrupting the streaming digital media program content. The user may proceed to click on links using, for example, the mouse 140 in order to access other web pages of the IIM/S web site 220 or to access other web sites on the Internet 201. The various link choices may include links to streaming media program content, links to other web pages of the IIM/S web site 220, links to other web sites on the global informational network (e.g., the Internet 201), and links to other links.

As an example, referring to FIG. 2, a user of the PC system 100 accesses the IIM/S website 220 (e.g., an Internet radio station) and views the IIM/S user interface view 110. The user then clicks on a “media program content” link, for example, to initiate the reception of streaming digital audio, via the Internet 201, from the server 210 which is hosting the IIM/S website (i.e., the Internet radio station). Once the user is comfortably listening to the selected media program content (which may be, for example, a song of a rock-n-roll artist), the user may then begin to click on other links related to the artist (e.g., tickets to concerts, biography of the artist, new album of the artist, etc.) while listening to the streaming audio.

In accordance with an alternative embodiment of the present invention, the IIM/S website 220 may also provide a directory of commercial advertisements that a user of the PC system 100 may access and view. The commercial advertisements may take many forms including streaming digital audio, streaming digital video, an HTML web page, etc.

In accordance with an embodiment of the present invention, a radio announcer for the Internet radio station may periodically encourage the user to perform searches using the search tool sub-view 120 and the associated search engine 250 provided by the IIM/S website 220, or to click on other link choices provided by the current sub-view 115.

In accordance with an alternative embodiment of the present invention, the IIM/S website 220 provides an Internet television station, broadcasting streaming video and audio over parts of the Internet 201 that provide enough bandwidth to accommodate the video and audio programming. The Internet television station operates in a similar manner to an Internet radio station (i.e., providing an integrated search engine and/or a directory of commercial advertisements).

The main television programming content picture may be reduced in size and displayed on the screen 130 to a user in a picture-in-picture (PIP)-type window when the user uses the search engine 250 or chooses to view a commercial advertisement. The main display area of the screen 130 is then used to display the resultant search view or the selected commercial advertisement. Alternatively, the search view or commercial advertisement may be displayed in a PIP-type window while the main television programming content picture remains in the main display area of the screen 130. Other user display options are possible as well. The television programming content may include, for example, news video clips or television shows.

As an alternative embodiment, the IIM/S web site 220 may provide an integrated web browser and media player (IWBMP) that can be downloaded to the user's PC 100 via the Internet 201. The IWPMP may be customized to have a unique “look and feel”. The IWPMP, once downloaded, is then used to access the streaming digital media program content 240 and the search engine 250 on the IIM/S website 220.

In accordance with an alternative embodiment of the present invention, the various components of the IIM/S web site (e.g., the streaming media program content 240, the search engine 250, the user interface view 110, and other associated web pages) are hosted on more than one server.

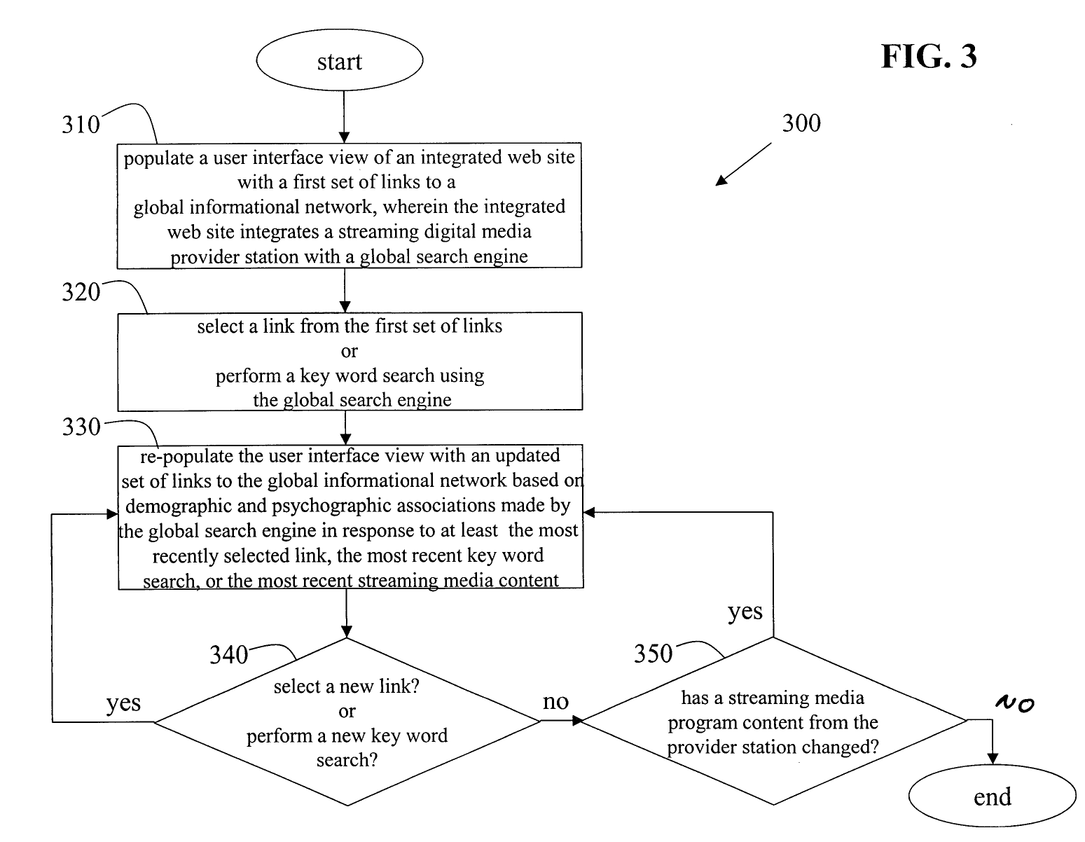

FIG. 3 is a flowchart of an embodiment of a method 300 to adapt the user interface view 110 of FIG. 1 based on user actions using the system 200 of FIG. 2, in accordance with various aspects of the present invention. In step 310, a user interface view of an integrated web site is populated with a first set of links to a global informational network, wherein the integrated web site integrates a streaming digital media provider station with a global search engine. In step 320, a link is selected from the first set of links or a key word search is performed using the global search engine. In step 330, the user interface view is re-populated with an updated set of links to the global informational network based on demographic and psychographic associations made by the global search engine in response to at least the most recently selected link, the most recent key word search performed, or the most recent streaming media content. In step 340, a decision is made as to whether or not to select a new link from the updated set of links or to perform a new key word search. If a new link is selected or a new key word search is performed, then the method reverts back to step 330 and re-populates the user interface view with an updated set of links. Otherwise, in step 350, the method checks if a streaming media program content (e.g., a song) from the provider station has changed. If so, then the method reverts back to step 330 and re-populates the user interface view with an updated set of links.

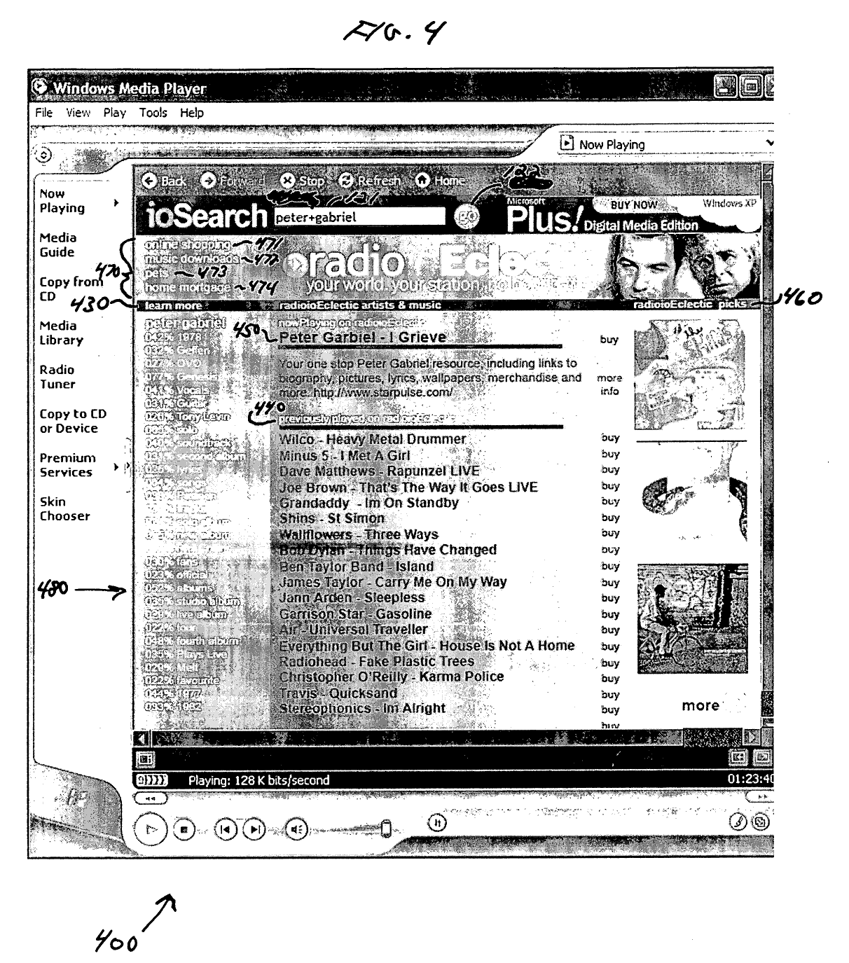

FIG. 4 illustrates a first exemplary embodiment of a IIM/S user interface view 400 provided by the system 200 of FIG. 2, in accordance with various aspects of the present invention. Referring to FIG. 4 to illustrate an example of the method 300 of FIG. 3 using the system 200 of FIG. 2, a user of the system 200 has accessed the IIM/S web site 220 and is listening to streaming digital audio content comprising the Peter Gabriel song “I Grieve” provided by the IIM/S web site 220. The user then enters the search key words “Peter Gabriel” in the text entry window 121 and clicks on the “go” icon 122 to initiate a search. The user interface view 400 is populated with a new set of links including a subset of “learn more” links 430, a subset of “previously played” links 440, a “Peter Gabriel” link 450, a subset of “picks” links 460, and a subset of other links 470 which includes links to “on-line shopping” 471, “music downloads” 472 for purchase, “pets” 473, and “home mortgages” 474. The links are presented in an informative, user-friendly format.

The new set of links populated in the user interface view 400 are generated in response to the search on the key words “Peter Gabriel” by the search engine 250 and sent by the IIM/S web site 220 to the PC 100 to be displayed in the current user interface view 400. The search engine 250 comprises an adaptive global search engine that performs a search of a global informational network (e.g., the Internet 201) in response to the key words “Peter Gabriel” by making predictive demographic and psychographic associations to the lifestyle of the user based on the key words “Peter Gabriel”. The associations are based on trying to predict a specific mood, situation, or set of products that the current streaming media program content (e.g., current song or artist) invokes to the user, and attempts to populate the view 400 accordingly.

As a result, the search engine 250 determines that the user is likely interested in “on-line shopping” 471, “music downloads” 472, “pets” 473, and “home mortgages” 474 and populates the view 400 with that subset of links 470 as well as a link 450 to “Peter Gabriel”-specific topics. Also, the search engine 250 determines that the user may want to learn more about other certain “Peter Gabriel”-related topics and populates the view 400 with the subset of links 430. Furthermore, the search engine 250 determines that a user may be interested in other musical picks provided by the integrated web site 220 and populates the view 400 with the subset of links 460. The subset of links 440 is also provided by the integrated web site 220 such that the user can select links associated with the artists and songs (i.e., streaming media program content) most recently streamed by the IIM/S web site 220 onto the Internet 201. The user is provided with many link choices to click on without having to enter key search words all the time.

In accordance with an embodiment of the present invention, the demographic and psychographic associations performed by the adaptive search engine 250 are accomplished in real time using adaptive inference techniques. In accordance with an alternative embodiment of the present invention, the demographic and psychographic associations performed by the adaptive search engine 250 are accomplished in real time using a set of predetermined association rules. In accordance with a further alternative embodiment of the present invention, the demographic and psychographic associations are performed using at least one relational data base.

Other association techniques are possible as well, in accordance with various embodiments of the present invention. For example, resultant associations are predetermined based on potential user actions with the user interface view 400 and the adaptive search engine 250 is programmed accordingly. In accordance with an embodiment of the present invention, at least some of the resultant links that get re-populated in a user interface view are links to web sites of paying sponsors of the IIM/S web site 220.

In accordance with an embodiment of the present invention, identification data known as ID3 and/or ID4 tag data are read and used as inputs to the search engine 250 to make the associations. ID3 and/or ID4 tag data comprise information such as song title, artist, album, year, genre, and comments. ID3 and/or ID4 data are provided as part of the streaming digital media content.

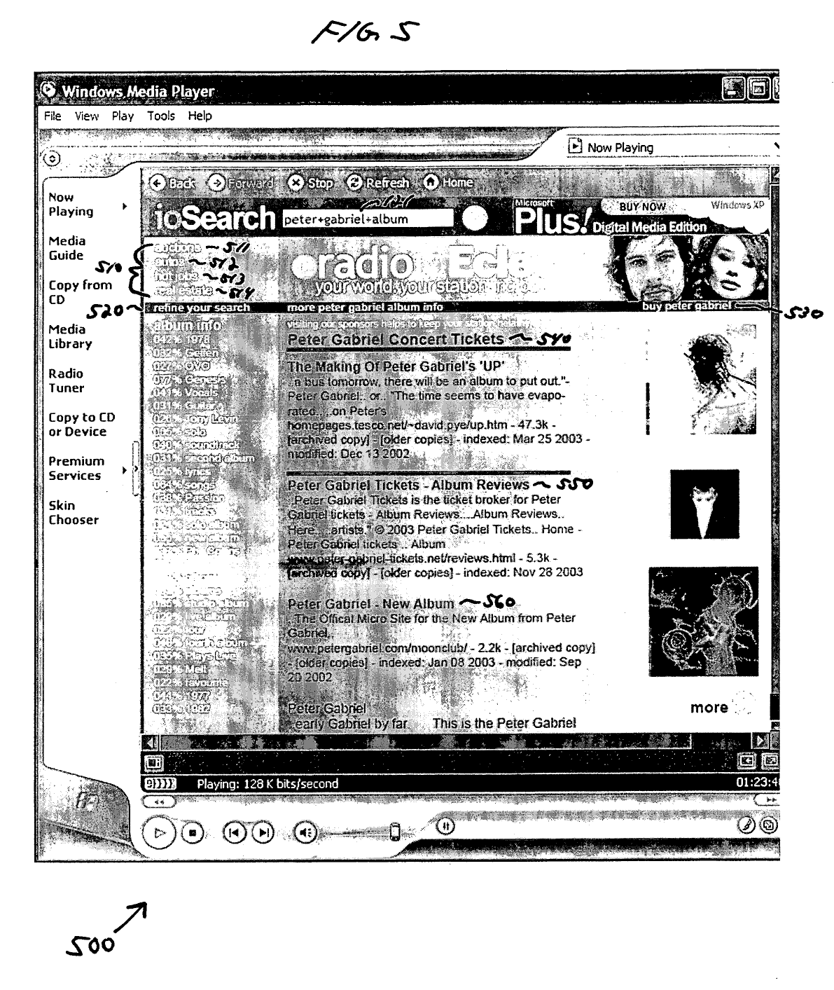

FIG. 5 illustrates a second exemplary embodiment of a IIM/S user interface view 500 provided by the system 200 of FIG. 2, in accordance with various aspects of the present invention. Continuing with the example, the user clicks on the “albums” link 480 in the “learn more” subset of links 430. As a result, referring to FIG. 5, the view 400 is re-populated with a new set of links shown in the updated user interface view 500. As a result, the search engine 250 determines that the user is likely interested in “auctions” 511, “autos” 512, “hot jobs” 513, and “real estate” 514 and populates the view 500 with that subset of links 510. Furthermore, the search engine 250 determines that a user may be interested in buying certain Peter Gabriel albums (e.g., CD's) and populates the view 500 with the subset of links 530 which provides links to a selection of Peter Gabriel albums for purchase. The view 500 is also populated with a link 540 to “Peter Gabriel concert tickets”, a link 550 to “album reviews”, and a link 560 to “Peter Gabriel's new album”. Other links may be provided as well, in accordance with various embodiments of the present invention.

The links populated in the view 500 are a result of the adaptive search engine 250 making predictive demographic and psychographic associations to the lifestyle of the user in response to having clicked on the “album” link 480 and/or having searched on the key words “Peter Gabriel”. In accordance with an embodiment of the present invention, when a user clicks on the “albums” link 480, the text in the text entry window 121 is updated just as if a paid search were performed (i.e., in effect, a paid search has been performed by clicking on the link 480).

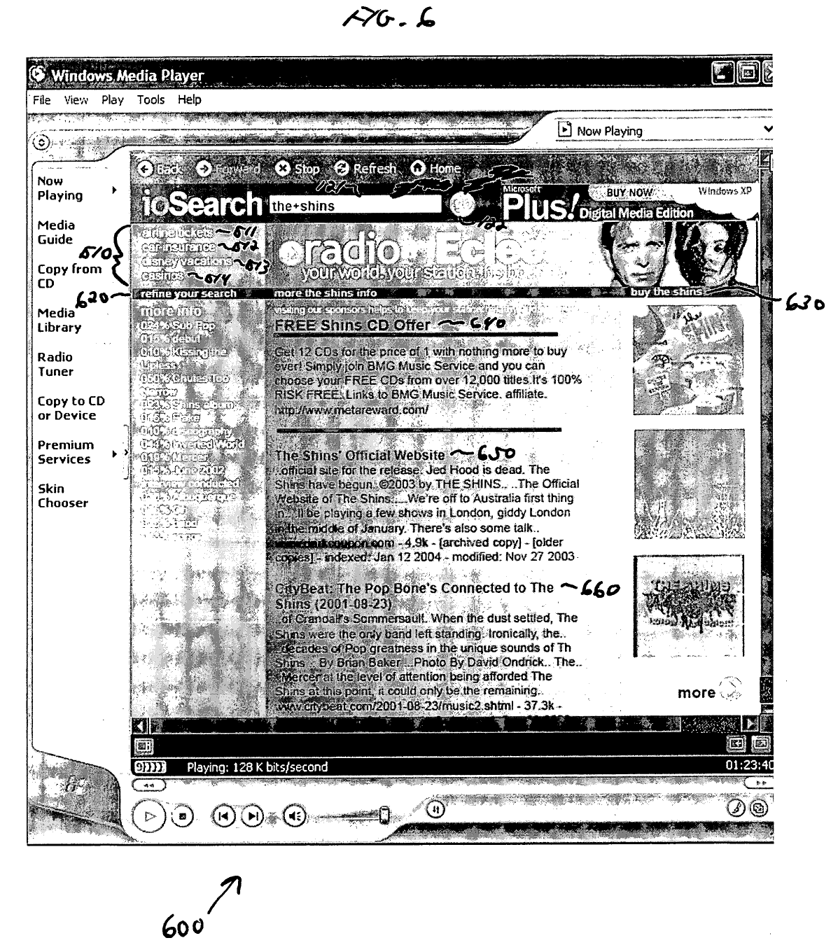

FIG. 6 illustrates a third exemplary embodiment of a IIM/S user interface view 600 provided by the system 200 of FIG. 2, in accordance with various aspects of the present invention. Continuing with the example, referring to FIG. 6, the user enters the key words “the shins” in the text entry window 121 and clicks on the “go” icon 122 to initiate a new search. As a result, the view 500 is re-populated with a new set of links shown in the updated user interface view 600. As a result, the search engine 250 determines that the user is likely interested in “airline tickets” 611, “car insurance” 612, “Disney vacations” 613, and “casinos” 614 and populates the view 600 with that subset of links 610. Also, the search engine 250 determines that the user may want to refine his search about “the shins”-related topics and populates the view 600 with the subset of links 620. Furthermore, the search engine 250 determines that a user may be interested in buying certain albums of “the shins” and populates the view 600 with the subset of links 630 which provides links to a selection of albums of “the shins”. The view 600 is also populated with a link 640 to “FREE Shins CD Offer”, a link 650 to “The Shins' Official Website”, and a link 660 to “CityBeat: The Pop Bone's Connected to The Shins (2001-08-23)”. Other links may be provided as well, in accordance with various embodiments of the present invention.

The links populated in the view 600 are a result of the adaptive search engine 250 making predictive demographic and psychographic associations to the lifestyle of the user in response to having searched on the key words “the shins” and/or having clicked on the “album” link 480 and/or having searched on the key words “Peter Gabriel”.

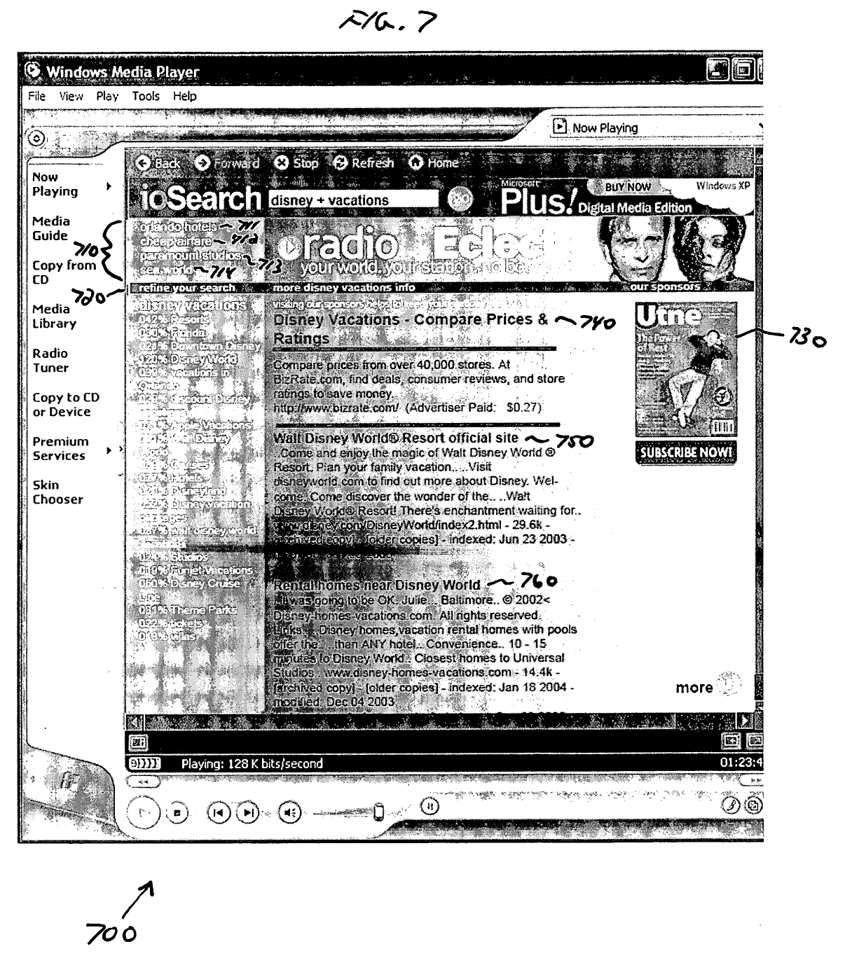

FIG. 7 illustrates a fourth exemplary embodiment of a IIM/S user interface view 700 provided by the system 200 of FIG. 2, in accordance with various aspects of the present invention. Continuing with the example, the user clicks on the “Disney vacations” link 613. As a result, referring to FIG. 7, the view 600 is re-populated with a new set of links shown in the updated user interface view 700. As a result, the search engine 250 determines that the user is likely interested in “Orlando hotels” 711, “cheap airfare” 712, “paramount studios” 713, and “sea world” 714 and populates the view 700 with that subset of links 710. Also, the search engine 250 determines that the user may want to refine his search about “Disney vacations”-related topics and populates the view 700 with the subset of links 720. Furthermore, the search engine 250 determines that a user may be interested in subscribing to a magazine and populates the view 700 with a link 730 to a magazine which sponsors the IIM/S web site 220. The view 700 is also populated with a link 740 to “Disney Vacations—Compare Prices & Ratings”, a link 750 to “Walt Disney World Resort official site”, and a link 760 to “Rental homes near Disney World”. Other links may be provided as well, in accordance with various embodiments of the present invention.

The links populated in the view 700 are a result of the adaptive search engine 250 making predictive demographic and psychographic associations to the lifestyle of the user in response to having clicked on the “Disney vacations” link 613 and/or having searched on the key words “the shins” and/or having clicked on the “album” link 480 and/or having searched on the key words “Peter Gabriel”.

Continuing with the example, the Peter Gabriel song “I Grieve”, being streamed from the IIM/S web site 220 to the PC 100 via the Internet 201, finishes playing on the PC 100 and a “new song” by a new artist begins streaming to the PC 100 from the IIM/S website 220. As a result, the view 700 is re-populated with a new set of links (not shown) by the adaptive search engine 250 based on making predictive demographic and psychographic associations to the lifestyle of the user in response to the “new song” being streamed to the user and/or having clicked on the “Disney vacations” link 613 and/or having searched on the key words “the shins” and/or having clicked on the “album” link 480 and/or having searched on the key words “Peter Gabriel”.

In accordance with an embodiment of the present invention, a user identifies himself to the IIM/S website 220 by logging in to the website 220. As a result, the website 220 can keep track of the user's listening habits and search habits over a long period of time. The search engine 250 can make associations based on such a user history.

In accordance with an embodiment of the present invention, the user of the system 200 may provide certain demographic information to the IIM/S web site 220 such as the user's age, the user's gender, and the user's zip code, for example. Other demographic information may be provided as well. The adaptive search engine 250 can use the user-provided demographic information as part of making predictive demographic and psychographic associations to determine which links to re-populate into the user interface view 110.

In accordance with an alternative embodiment of the present invention, the IIM/S web site 220 may employ more than one search engine 250 to perform the predictive demographic and psychographic associations and searches and, for example, employ relational databases.

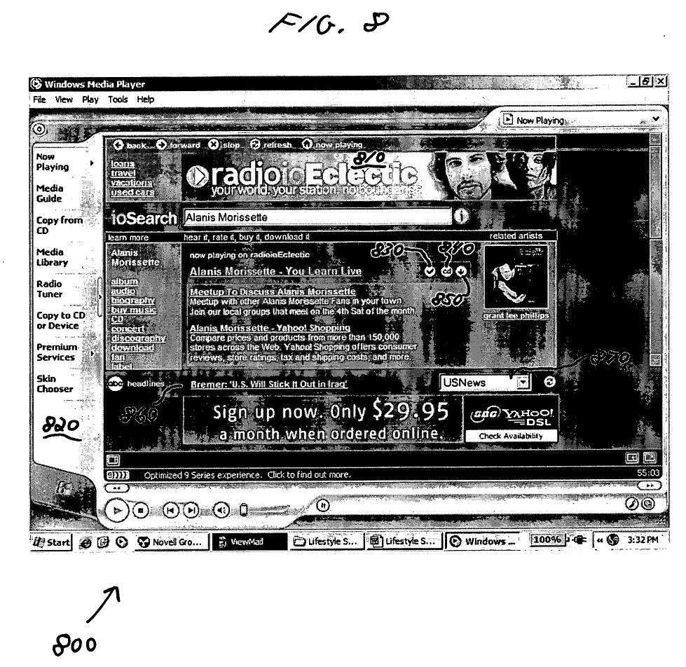

The IIM/S user interface view 110 can take many forms, in accordance with various embodiments of the present invention. For example, FIG. 8 illustrates a fifth exemplary embodiment of a IIM/S user interface view 800 provided by the system 200 of FIG. 2, in accordance with various aspects of the present invention. The user interface view 800 comprises an HTML page 810 embedded into a media player control window 820. The HTML page 810 includes an Internet radio station subview providing various populated links, and a search tool subview providing search capability as previously described herein.

In accordance with an embodiment of the present invention, the media player module 180, which provides the media player control window 820, is previously installed on the PC system 100 and is manually launched by a user of the PC system 100 or is automatically launched when the IIM/S web site 220 is accessed by the PC system 100. The IIM/S website 220 automatically embeds the HTML page 810 when the media player is launched.

In accordance with an alternative embodiment of the present invention, the media player module 180, which provides the media player control window 820, is automatically downloaded from the IIM/S website 220 to the PC system 100 with the embedded HTML page 810 when the IIM/S web site 220 is accessed by the PC system 100.

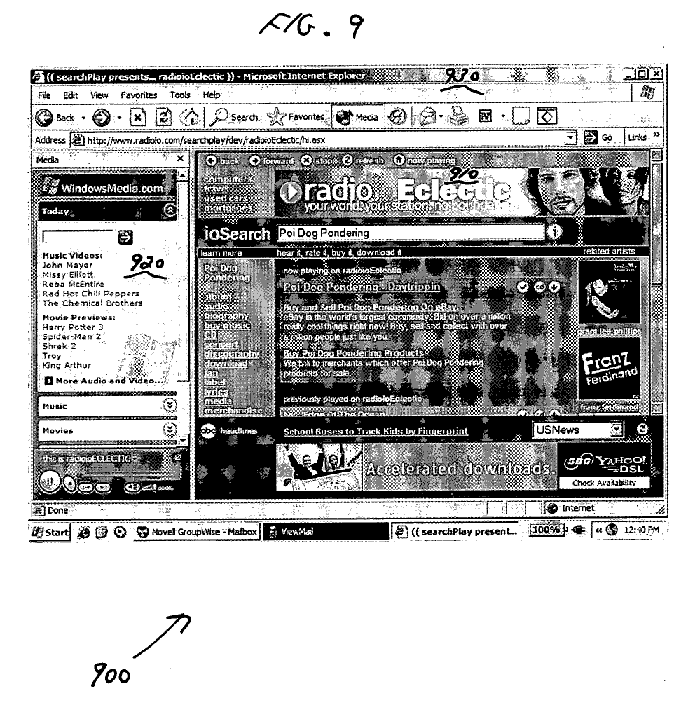

FIG. 9 illustrates a sixth exemplary embodiment of a IIM/S user interface view 900 provided by the system 200 of FIG. 2, in accordance with various aspects of the present invention. The user interface view 900 comprises an HTML page 910 and a media player control view 920 embedded into a web browser window 930. The HTML page 910 includes an Internet radio station subview providing various populated links, and a search tool subview providing search capability as previously described herein. The media player control view 920 is distinct and to the side of the HTML page 910.

In accordance with an embodiment of the present invention, the media player module 180, which provides the media player control view 920, is previously installed on the PC system 100 and is manually launched by a user of the PC system 100 or is automatically launched when the IIM/S web site 220 is accessed by the PC system 100. The IIM/S website 220 automatically embeds the HTML page 910 when the IIM/S web site 220 is accessed.

In accordance with an alternative embodiment of the present invention, the media player module 180, which provides the media player control view 920, is automatically downloaded from the IIM/S website 220 to the PC system 100 with the HTML page 910 when the IIM/S web site 220 is accessed by the PC system 100.

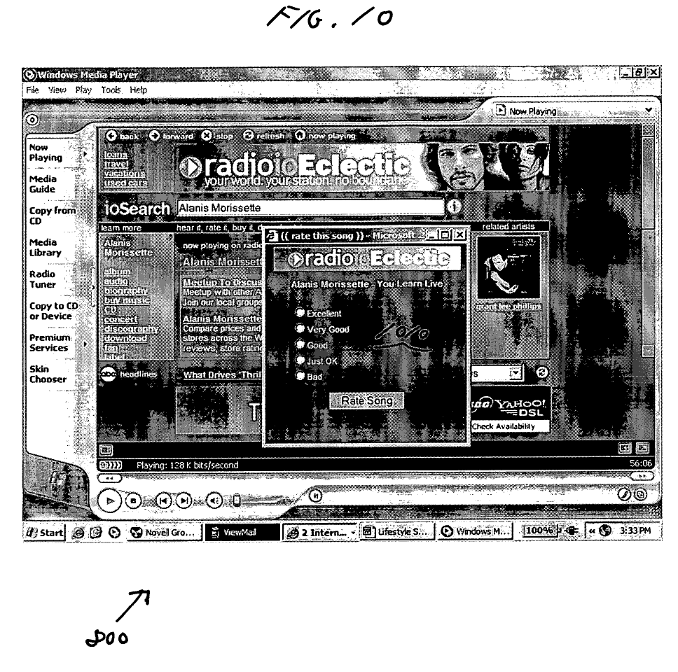

Referring again to FIG. 8, the user interface view 800 provides additional functionality in accordance with an embodiment of the present invention. For example, the icon button 830 may be selected to allow a user to rate a current song that is playing. When the icon 830 is clicked on, the rating choices 1010 shown in FIG. 10 appear. The user may select and submit a rating for a current song that is being streamed to the PC system 100 and played by the media player 180. If the user desires to purchase the CD corresponding to the current song, the user may click on the icon button 840 which will take the user to a web site that allows the user to purchase the CD. Similarly, if the user desires to download the current song as, for example, an MP3 file, the user may click on the icon button 850 which will take the user to a web site that allows the user to purchase and download an MP3 file corresponding to the current song.

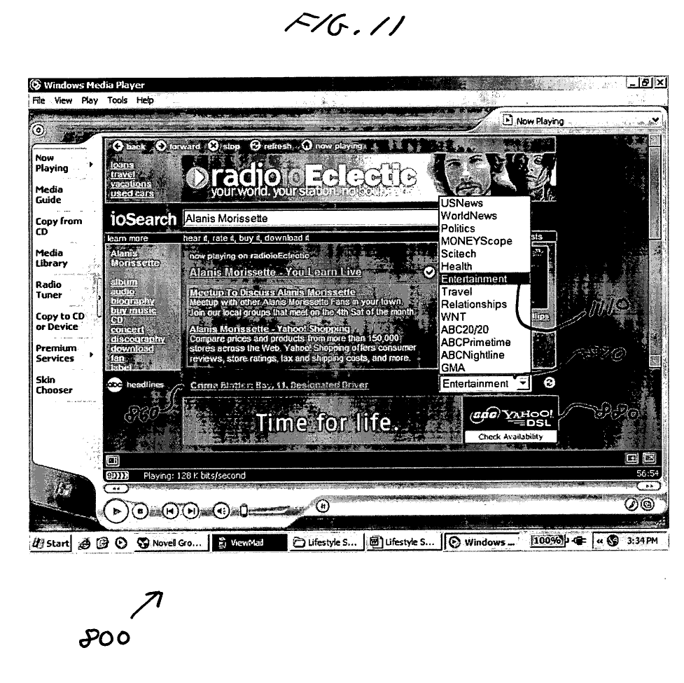

Referring again to FIG. 8, a news story link 860 is provided which allows a user to access a web site that provides a particular news story. The title of the link 860 periodically changes to allow a user to select different news stories. A user can select from a list of various media sources 870 to change the category of the link 860. For example, a user may select the “entertainment” category 1110 (see FIG. 11). As a result, the link 860 will no longer be to news stories but will, instead, be to stories related to entertainment.

In accordance with an embodiment of the present invention, streaming banners 880 are displayed and updated within the user interface view 800. The streaming banners 880 serve as paid advertisements and links to the advertisers' web sites.

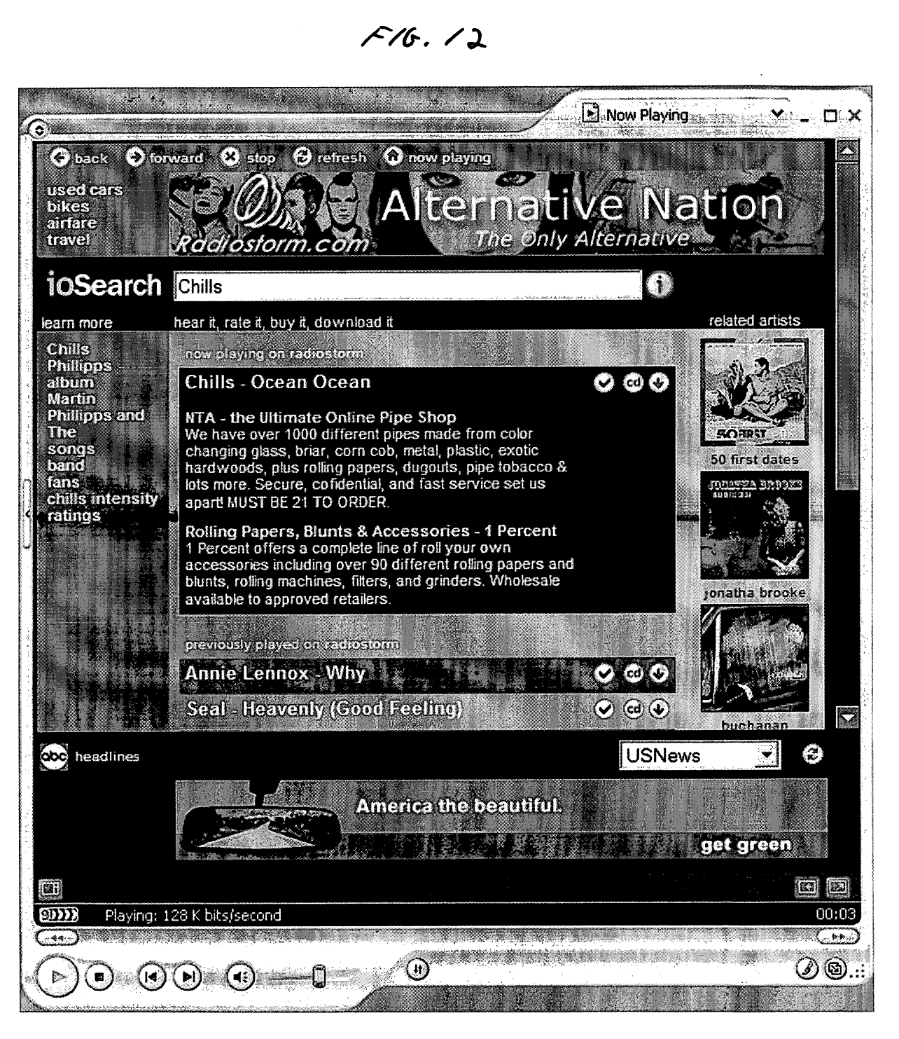

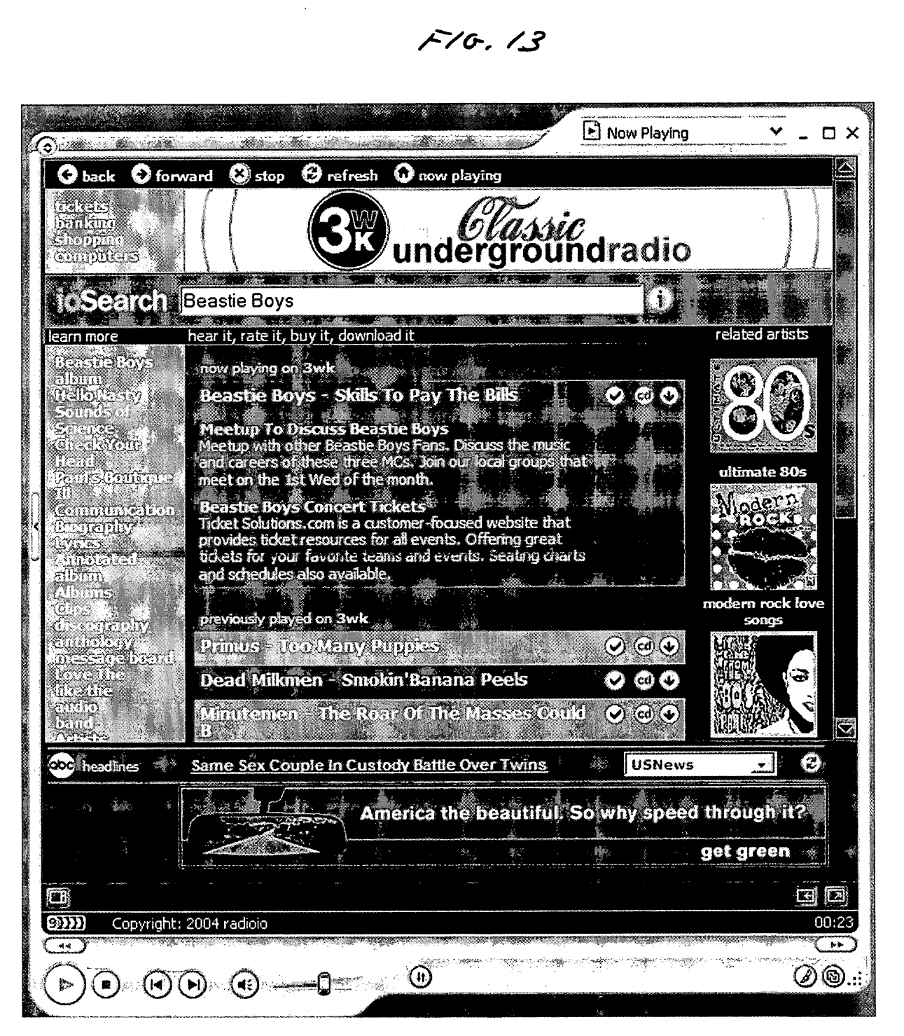

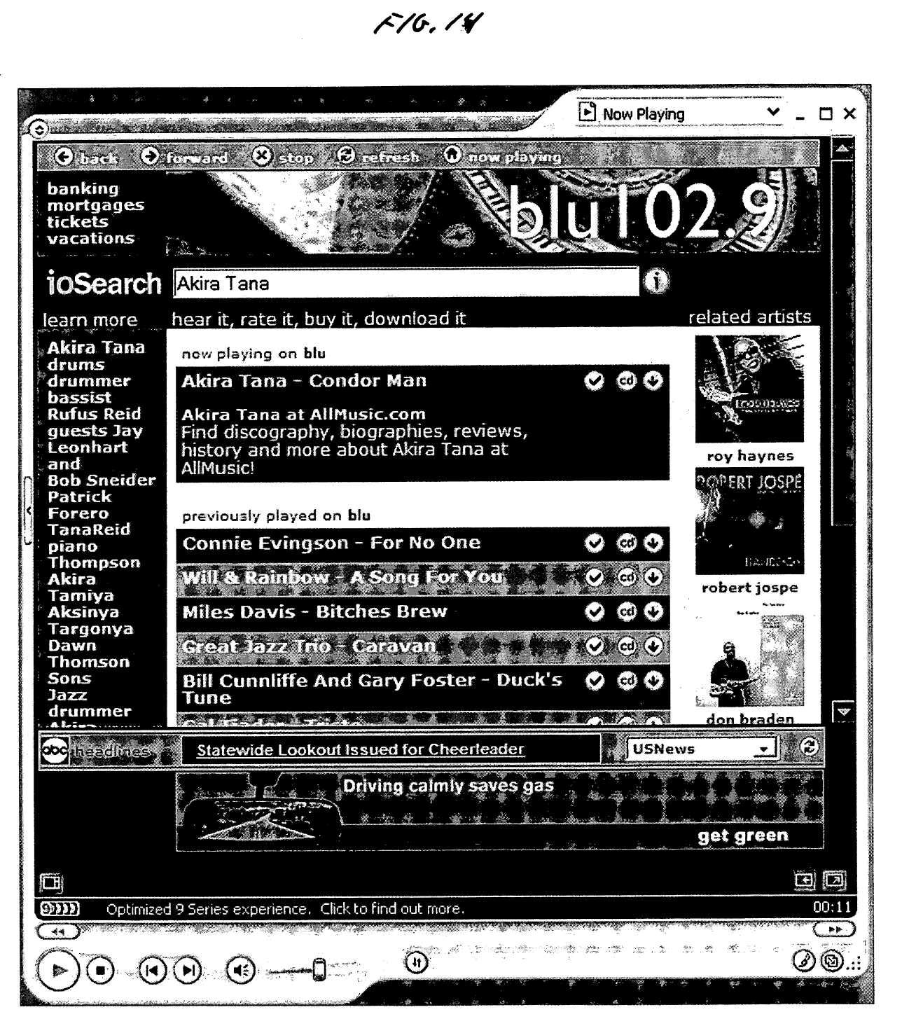

FIGS. 12-14 each illustrate an exemplary embodiment of a user interface view for a unique radio station, in accordance with various aspects of the present invention. The format of the user interface views of FIGS. 12-14 is the same as that of FIG. 8 however, each represents a different radio station (e.g., “Radiostorm”, “3wk”, and “blu 102.9”).

In accordance with a further alternative embodiment of the present invention, a media player object is embedded into a frame-less pop-up window and is provided by the provider of the Internet radio station from the server 210. HTML is used to show the “now playing” information and the search view information in the pop-up window. The embedded media player object is used to play the stream of digital media data in any one of, for example, three selectable formats including QuickTime, real or MP3, or Windows Media. Each selectable format includes its own stream controls which are displayed near the bottom of the pop-up user interface view. The user selects which media player to have embedded and a user interface view is provided to the user which includes a navigation tool near the top of the user interface view, populated search/play area which includes populated links based on a presearch which was performed by the search engine using ID3/ID4 tag data. A separate media player is not needed on the user's PC. The user interface view constitutes a search player which is a graphical image which has a media player built-in such that the embedded media player allows consumption of the media.

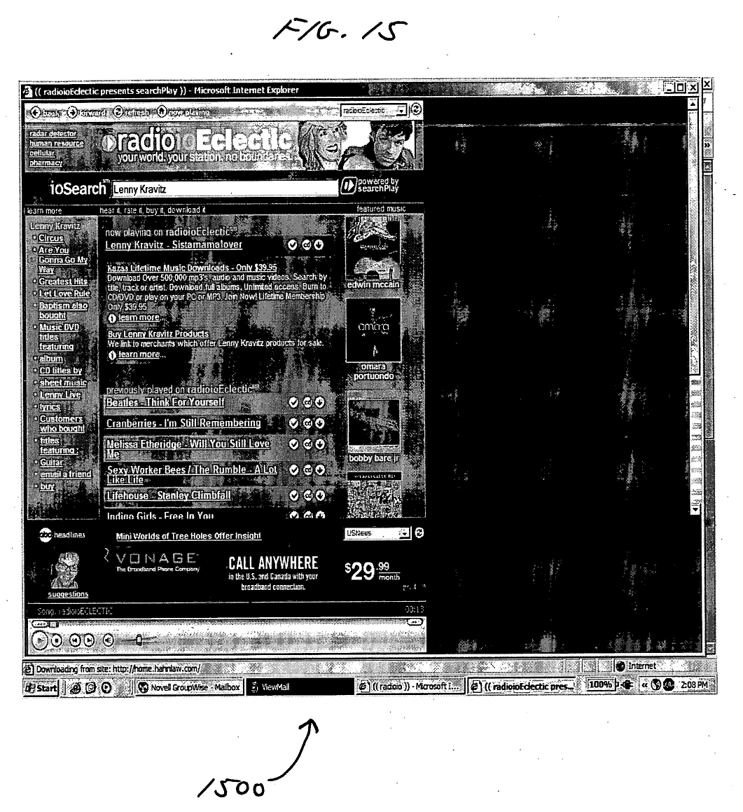

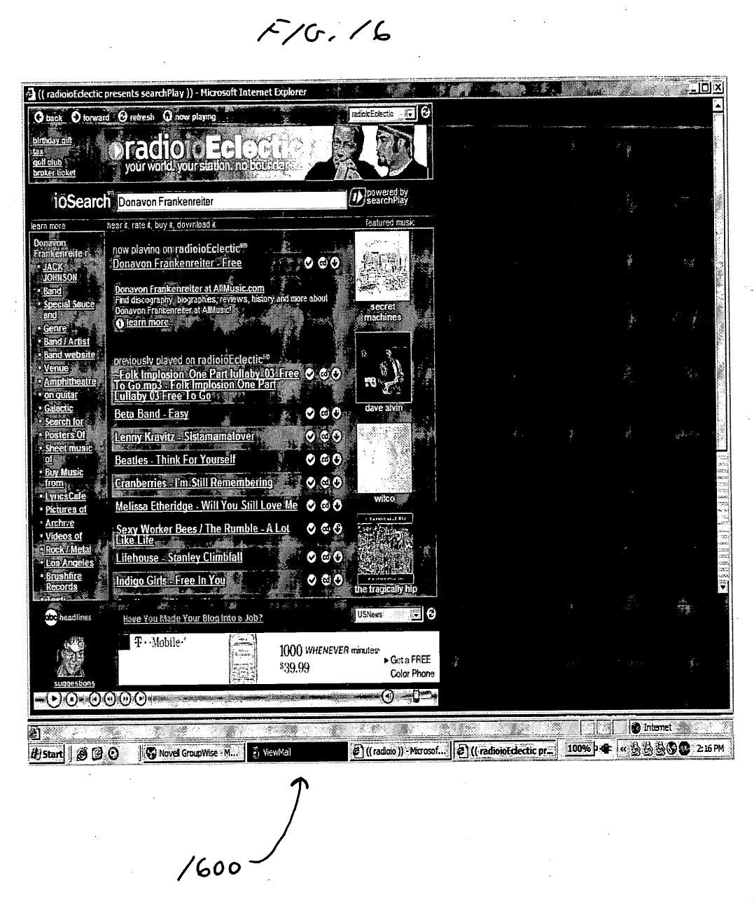

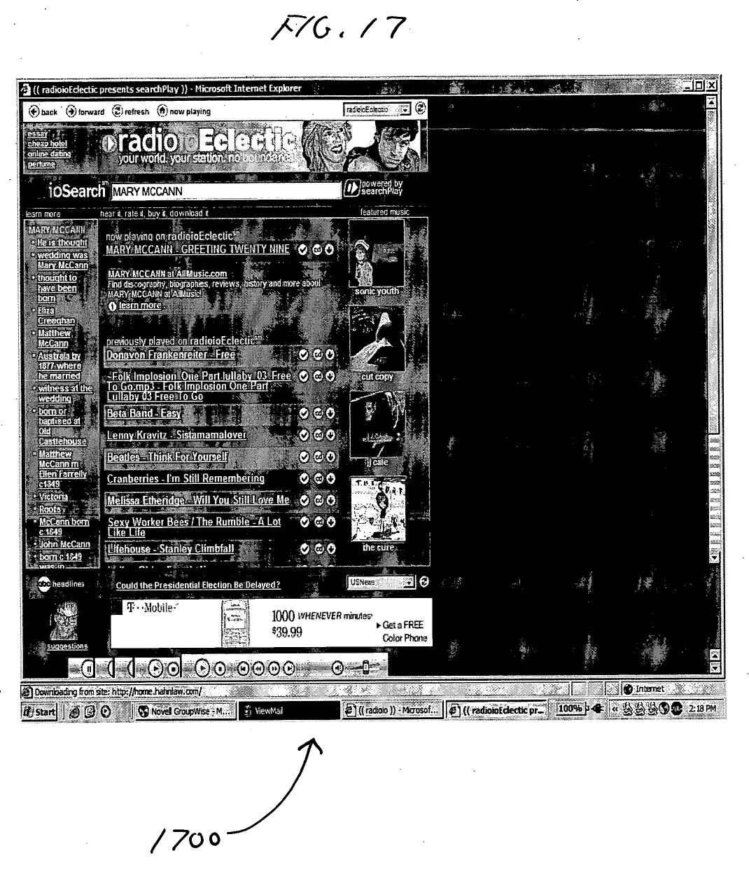

FIGS. 15-17 each illustrate an exemplary embodiment of a user interface view (pop-up window) having a selected embedded media player, in accordance with various aspects of the present invention. FIG. 15 represents a search player user interface view 1500 comprising an embedded windows media player object. FIG. 16 represents a search player user interface view 1600 comprising an embedded QuickTime media player object. FIG. 17 represents a search player user interface view 1700 comprising an embedded REAL or MP3 media player object. The stream controls, which are displayed near the bottom of the pop-up user interface view, are different for each type of embedded media player.

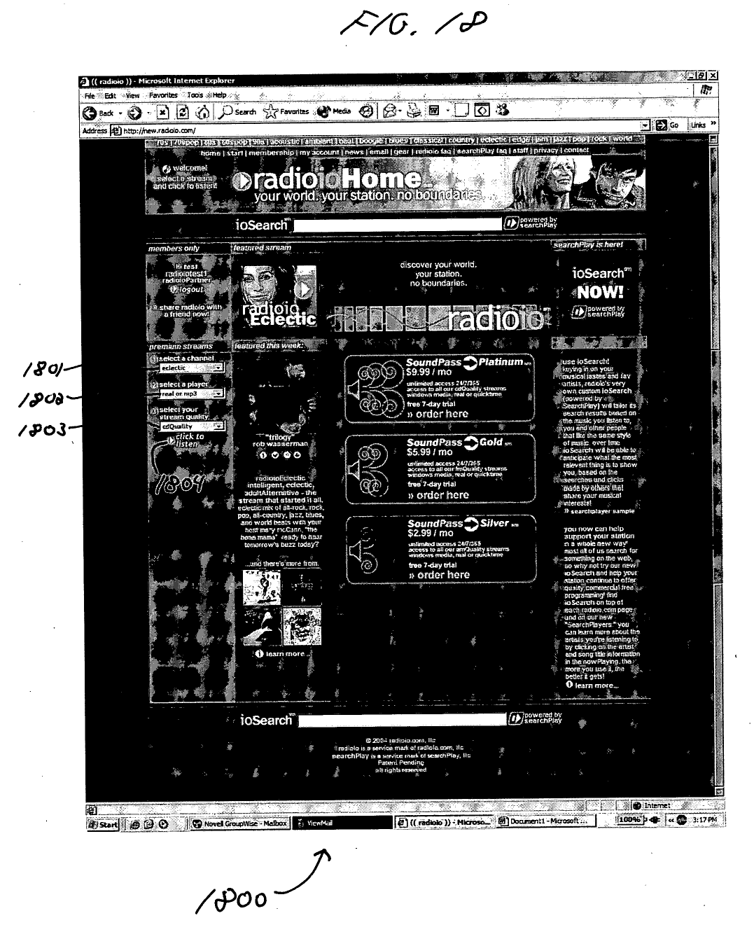

FIG. 18 illustrates an exemplary embodiment of a user interface view 1800 showing certain user-selectable choices (1801-1803), in accordance with various aspects of the present invention. The user may select a channel 1801 corresponding to a genre of music, a media player 1802 (e.g., Windows Media, QuickTime, Real), and a quality of the stream 1803 (e.g., AM, FM, CD). When the user then selects “click to listen” 1804, the pop-up window of FIGS. 15-17 appears with the selected embedded media player object.

In summary, methods to adapt a user interface view of an integrated media/search web site are provided. The methods rely on an adaptive search engine which is part of the integrated web site. The adaptive search engine monitors user actions such as links clicked on and searches performed and automatically updates the user interface view with a new set of links based on the user actions. The search engine makes demographic and psychographic associations to the user in order to determine the new set of links.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to adapt a user interface view, provided by an integrated media/search web site via a global informational network, based on a user's lifestyle, said method comprising:
populating said user interface view with a first set of links to said global informational network, wherein said integrated web site integrates at least one streaming digital media provider station with at least one global search engine;
selecting a first link from said first set of links;
re-populating said user interface view with a second set of links to said global informational network based on demographic and psychographic associations made by said at least one global search engine in response to selecting said first link;
selecting a second link from said second set of links; and
re-populating said user interface view with a third set of links to said global informational network based on demographic and psychographic associations made by said at least one global search engine in response to selecting at least said second link.

2. The method of claim 1 further comprising:
selecting a third link from said third set of links; and
re-populating said user interface view with a fourth set of links to said global informational network based on demographic and psychographic associations made by said at least one global search engine in response to selecting at least said third link.

3. The method of claim 2 wherein said first, second, third, and fourth set of links comprise links to at least one of streaming media program content, other web pages of said integrated web site, other web sites, and other links.

4. The method of claim 2 wherein said associations are predetermined and pre-programmed into said at least one global search engine before each of said first, second, and third links is selected.

5. The method of claim 2 wherein said associations are determined in real time by said at least one global search engine as each of said first, second, and third links is selected.

6. The method of claim 5 wherein said at least one global search engine determines said associations in real time using adaptive inference techniques.

7. The method of claim 5 wherein said at least one global search engine determines said associations in real time using a set of predetermined association rules.

8. The method of claim 3 wherein said integrated web site is accessed via said global informational network using a personal computer (PC) system, which includes a browser, and wherein said PC system is connected to said global informational network.

9. The method of claim 8 wherein said PC system includes a media player to play said streaming media program content.

10. The method of claim 1 wherein said global informational network comprises the Internet.

11. The method of claim 1 wherein said streaming digital media provider station comprises an Internet radio station providing streaming digital audio content.

12. The method of claim 1 wherein said streaming digital media provider station comprises an Internet television station providing streaming digital video and audio content.

13. The method of claim 1 wherein said user interface view of said integrated web site includes a key word search text entry box and an icon to initiate a search on entered key search words.

14. The method of claim 1 wherein said global search engine provides an ability to search at least the World Wide Web (WWW).

15. The method of claim 3 wherein said streaming media program content comprises streaming digital audio.

16. The method of claim 3 wherein said streaming media program content comprises streaming digital video.

17. The method of claim 3 wherein said streaming media program content comprises a combination of streaming digital video and audio.

18. The method of claim 1 wherein said integrated web site comprises an Internet radio station with Internet search capability provided by said integrated global search engine.

19. The method of claim 1 wherein said integrated web site comprises an Internet television station with Internet search capability provided by said integrated global search engine.

20. The method of claim 1 wherein said integrated web site is hosted on at least one server connected to said global informational network.

21. The method of claim 1 wherein said second set of links includes at least one link to a web site associated with at least one artist associated with said selected first link.

22. The method of claim 1 wherein said third set of links includes at least one link to a web site associated with at least one artist associated with at least said selected second link.

23. The method of claim 2 wherein said fourth set of links includes at least one link to a web site associated with at least one artist associated with at least said selected third link.

24. The method of claim 1 wherein said second set of links includes at least one link to purchasable music of at least one artist associated with said selected first link.

25. The method of claim 1 wherein said third set of links includes at least one link to purchasable music of at least one artist associated with at least said selected second link.

26. The method of claim 2 wherein said fourth set of link includes at least one link to purchasable music of at least one artist associated with at least said selected third link.

27. The method of claim 1 wherein said first, second, and third set of links include at least one link to a web site of at least one paying sponsor of said integrated web site.

28. The method of claim 2 wherein said fourth set of links includes at least one link to a web site of at least one paying sponsor of said integrated web site.

29. The method of claim 1 further comprising:
collecting first demographic information from a user of said integrated web site via said global informational network; and
re-populating said user interface view with a fourth set of links to said global informational network based on demographic and pyschographic associations made by said at least one global search engine in response to at least said collected first demographic information.

30. The method of claim 29 further comprising:
collecting second demographic information from a user of said integrated web site via said global informational network; and
re-populating said user interface view with a fifth set of links to said global informational network based on demographic and pyschographic associations made by said at least one global search engine in response to at least said collected second demographic information.

31. The method of claim 30 wherein each of said first and second demographic information includes at least one of a user's age, a user's zip code, and a user's gender.

32. A method to adapt a user interface view, provided by an integrated media/search web site via a global informational network, based on a user's lifestyle, said method comprising:
populating said user interface view with a first set of links to said global informational network, wherein said integrated web site integrates at least one streaming digital media provider station with at least one global search engine;
entering at least one first search key word into a key search word text entry box of said user interface view;
initiating a first search of said global informational network based on said at least one first search key word using said at least one global search engine; and
re-populating said user interface view with a second set of links to said global informational network based on demographic and pyschographic associations made by said at least one global search engine in response to said at least one first search key word.

33. The method of claim 32 further comprising:
entering at least one second search key word into said key search word text entry box of said user interface view;
initiating a second search of said global informational network based on said at least one second search key word using said at least one global search engine; and
re-populating said user interface view with a third set of links to said global informational network based on demographic and pyschographic associations made by said at least one global search engine in response to said at least one second search key word.

34. The method of claim 32 further comprising:
selecting a first link from said second set of links; and
re-populating said user interface view with a third set of links to said global informational network based on demographic and pyschographic associations made by said at least one global search engine in response to said selected first link.

35. The method of claim 33 wherein said first, second, and third set of links comprise links to at least one of streaming media program content, other web pages of said integrated web site, other web sites, and other links.

36. The method of claim 34 wherein said first, second, and third set of links comprise links to at least one of streaming media program content, other web pages of said integrated web site, other web sites, and other links.

37. The method of claim 33 wherein said associations are predetermined and pre-programmed into said at least one global search engine before each of said first and second searches is performed.

38. The method of claim 33 wherein said associations are made in real time by said at least one global search engine as each of said first and second searches is performed.

39. The method of claim 38 wherein said at least one global search engine makes said associations in real time using adaptive inference techniques.

40. The method of claim 38 wherein said at least one global search engine makes said associations in real time using a set of predetermined association rules.

41. The method of claim 34 wherein said associations are predetermined and pre-programmed into said at least one global search engine before said first search is performed and said first link is selected.

42. The method of claim 34 wherein said associations are made in real time by said at least one global search engine as said first search is performed and as said first link is selected.

43. The method of claim 42 wherein said at least one global search engine makes said associations in real time using adaptive inference techniques.

44. The method of claim 42 wherein said at least one global search engine makes said associations in real time using a set of predetermined association rules.

45. The method of claim 35 wherein said integrated web site is accessed via said global informational network using a personal computer (PC) system, which includes a browser, and wherein said PC system is connected to said global informational network.

46. The method of claim 36 wherein said integrated web site is accessed via said global informational network using a personal computer (PC) system, which includes a browser, and wherein said PC system is connected to said global informational network.

47. The method of claim 45 wherein said PC system includes a media player to play said streaming media program content.

48. The method of claim 46 wherein said PC system includes a media player to play said streaming media program content.

49. The method of claim 32 wherein said global informational network comprises the Internet.

50. The method of claim 32 wherein said streaming digital media provider station comprises an Internet radio station providing streaming digital audio content.

51. The method of claim 32 wherein said streaming digital media provider station comprises an Internet television station providing streaming digital video and audio content.

52. The method of claim 32 wherein said global search engine provides an ability to search at least the World Wide Web (WWW).

53. The method of claim 35 wherein said streaming media program content comprises streaming digital audio.

54. The method of claim 35 wherein said streaming media program content comprises streaming digital video.

55. The method of claim 35 wherein said streaming media program content comprises a combination of streaming digital video and audio.

56. The method of claim 36 wherein said streaming media program content comprises streaming digital audio.

57. The method of claim 36 wherein said streaming media program content comprises streaming digital video.

58. The method of claim 36 wherein said streaming media program content comprises a combination of streaming digital video and audio.

59. The method of claim 32 wherein said integrated web site comprises an Internet radio station with Internet search capability provided by said integrated global search engine.

60. The method of claim 32 wherein said integrated web site comprises an Internet television station with Internet search capability provided by said integrated global search engine.

61. The method of claim 32 wherein said integrated web site is hosted on at least one server connected to said global informational network.

62. The method of claim 32 wherein said second set of links includes at least one link to a web site associated with at least one artist associated with said at least one first search key word.

63. The method of claim 33 wherein said third set of links includes at least one link to a web site associated with at least one artist associated with said at least one second search key word.

64. The method of claim 34 wherein said third set of links includes at least one link to a web site associated with at least one artist associated with said selected first link.

65. The method of claim 32 wherein said second set of links includes at least one link to purchasable music of at least one artist associated with said at least one first search key word.

66. The method of claim 33 wherein said third set of links includes at least one link to purchasable music of at least one artist associated with said at least one second search key word.

67. The method of claim 34 wherein said third set of links includes at least one link to purchasable music of at least one artist associated with said selected first link.

68. The method of claim 32 wherein said first and second set of links include at least one link to a web site of at least one paying sponsor of said integrated web site.

69. The method of claim 33 wherein said third set of links includes at least one link to a web site of at least one paying sponsor of said integrated web site.

70. The method of claim 34 wherein said third set of links includes at least one link to a web site of at least one paying sponsor of said integrated web site.

71. The method of claim 32 further comprising:
collecting first demographic information from a user of said integrated web site via said global informational network; and
re-populating said user interface view with a third set of links to said global informational network based on demographic and pyschographic associations made by said at least one global search engine in response to at least said collected first demographic information.

72. The method of claim 71 further comprising:
collecting second demographic information from a user of said integrated web site via said global informational network; and
re-populating said user interface view with a fourth set of links to said global informational network based on demographic and pyschographic associations made by said at least one global search engine in response to at least said collected second demographic information.

73. The method of claim 72 wherein each of said first and second demographic information includes at least one of a user's age, a user's zip code, and a user's gender.

74. A method to adapt a user interface view, provided by an integrated media/search web site via a global informational network, based on a user's lifestyle, said method comprising:
populating said user interface view with a first set of links to said global informational network, wherein said integrated web site integrates at least one streaming digital media provider station with at least one global search engine;
selecting a first link from said first set of links; and
re-populating said user interface view with a second set of links to said global informational network based on demographic and pyschographic associations made by said at least one global search engine in response to said selected first link.

75. The method of claim 74 further comprising:
entering at least one first search key word into a key search word text entry box of said user interface view;
initiating a first search of said global informational network based on said at least one first search key word using said at least one global search engine; and
re-populating said user interface view with a third set of links to said global informational network based on demographic and pyschographic associations made by said at least one global search engine in response to said at least one first search key word.

76. The method of claim 74 further comprising:
selecting a second link from said second set of links; and
re-populating said user interface view with a third set of links to said global informational network based on demographic and pyschographic associations made by said at least one global search engine in response to said selected second link.

77. The method of claim 74 further comprising:
collecting first demographic information from a user of said integrated web site via said global informational network; and
re-populating said user interface view with a third set of links to said global informational network based on demographic and pyschographic associations made by said at least one global search engine in response to at least said collected first demographic information.

78. The method of claim 77 further comprising:
collecting second demographic information from a user of said integrated web site via said global informational network; and
re-populating said user interface view with a fourth set of links to said global informational network based on demographic and pyschographic associations made by said at least one global search engine in response to at least said collected second demographic information.

79. The method of claim 78 wherein each of said first and second demographic information includes at least one of a user's age, a user's zip code, and a user's gender.

80. A method to adapt a user interface view, provided by an integrated media/search web site via a global informational network, based on a user's lifestyle, said method comprising:
populating said user interface view with a first set of links to said global informational network, wherein said integrated web site integrates at least one streaming digital media provider station with at least one global search engine;
selecting a first link to download a first streaming media program content followed by at least a second streaming media program content to a user's personal computer (PC);
re-populating said user interface view with a second set of links to said global informational network based on demographic and pyschographic associations made by said at least one global search engine in response to said first streaming media program content; and
re-populating said user interface view with a third set of links to said global informational network based on demographic and pyschographic associations made by said at least one global search engine in response to said second streaming media program content.

81. The method of claim 80 further comprising re-populating said user interface view with a fourth set of links to said global informational network based on demographic and pyschographic associations made by said at least one global search engine in response to a third streaming media program content.

82. The method of claim 80 wherein said first streaming media program content comprises a first song and said second streaming media program content comprises a second song.

83. The method of claim 81 wherein said third streaming media program content comprises a third song.
